(19) United States
(12) Patent Application Publication
(10) Pub. No.: US 2026/0106442 A1
(43) Pub. Date: Apr. 16, 2026

(54) BROADBAND INTELLIGENT VIBRATION DAMPER FOR POWER TRANSMISSION LINES AND OPTIMIZATION DESIGN METHOD THEREFOR

(71) Applicants: POWERCHINA SEPCO1 ELECTRIC POWER CONSTRUCTION CO., LTD., Jinan (CN); SHANDONG UNIVERSITY, Jinan (CN); POWERCHINA SICHUAN ELECTRIC POWER ENGINEERING CO., LTD., Chengdu (CN); POWERCHINA CHENGDU ELECTRIC POWER FITTINGS CO., LTD., Chengdu (CN)

(72) Inventors: Guodong SHAO, Jinan (CN); Jianping ZHANG, Jinan (CN); Li TIAN, Jinan (CN); Jiyong PANG, Jinan (CN); Cong XIAO, Jinan (CN); Gonghua LI, Jinan (CN); Zhiyi LIU, Jinan (CN); Xiangrui MENG, Jinan (CN); Ran LIU, Jinan (CN); Jie ZOU, Jinan (CN); Ge ZHAO, Jinan (CN); Dong LI, Jinan (CN)

(73) Assignees: POWERCHINA SEPCO1 ELECTRIC POWER CONSTRUCTION CO., LTD., Jinan (CN); SHANDONG UNIVERSITY, Jinan (CN); POWERCHINA SICHUAN ELECTRIC POWER ENGINEERING CO., LTD., Chengdu (CN); POWERCHINA CHENGDU ELECTRIC POWER FITTINGS CO., LTD., Chengdu (CN)

(21) Appl. No.: 19/417,149

(22) Filed: Dec. 11, 2025

(30) Foreign Application Priority Data
Feb. 27, 2025 (CN) 202510224688.X

(51) Int. Cl. H02G 7/14; F16F 7/116

(52) U.S. Cl. CPC H02G 7/14; F16F 7/116

(57) ABSTRACT

A vibration damper comprises a clamp, a steel strand cluster, and two vibration absorbing heads, the clamp is mounted at a middle portion of the steel strand cluster, and the two vibration absorbing heads are respectively mounted at two ends of the steel strand cluster; the vibration absorbing head comprises a head portion, one end of the head portion is provided with a groove, a bottom surface of the groove is connected to the steel strand cluster, and a bending damper is disposed between the steel strand cluster and a sidewall of the groove; the bending damper has one end connected to the steel strand cluster via a fixing apparatus and the other end connected to the sidewall of the groove of the head portion via an adjusting apparatus; A bending degree of a bending damper can be adjusted via an adjusting apparatus.

### CROSS-REFERENCE TO RELATED APPLICATIONS

This application claims priority to Chinese Patent Application No. 202510224688.X with a filing date of Feb. 27, 2025. The content of the aforementioned application, including any intervening amendments thereto, is incorporated herein by reference.

### TECHNICAL FIELD

The present disclosure pertains to the technical field of disaster prevention and control equipment for power transmission lines, specifically the technical field of vibration dampers, and particularly relates to a broadband intelligent vibration damper for power transmission lines and an optimization design method therefor.

### BACKGROUND

Power transmission lines are a core component of modern power systems, characterized by large spans and highly flexible structures. This design allows power transmission lines to span long distances, but also renders them somewhat vulnerable to external environmental influences. For example, when wind loads continuously act on a wire, the wire generates high-frequency vibrations. Such vibrations cause slight bending and deformation at the wire's hanging position. This repeated bending and deformation, over time, leads to fatigue damage in the wire, gradually weakening the structural integrity and load-bearing capacity of the wire, thereby shortening its service life.

Based on the causes of wire vibration and the forms of wire vibration, wire vibrations can be classified into breeze vibration, sub-span vibration, galloping, ice-shedding jump, transverse magnetic impact corona galloping, short-circuit vibration, turbulence vibration, and the like, among which breeze vibration and galloping have a particularly significant impact on equipment safety. Breeze vibration is a phenomenon of resonance caused by the frequency of aerodynamic impact matching a natural frequency of the tensioned wire within a span. The necessary condition for generating vibration is the uniformity of airflow and the consistency of its direction. When the energy imparted by the wind to the wire is sufficient, the wire's vibration can be sustained; this minimum wind speed value is called a lower limit, typically 0.5 m/s. The maximum wind speed that can still cause wire vibration as it increases is called an upper limit, with a typical upper limit value of 4-7 m/s. Beyond this upper limit, the wire ceases to vibrate.

For high-voltage lines with greater erection heights, the airflow in the plane of the ground wire is less affected by surface ground wires, making breeze vibration more likely to occur. A greater erection tension leads to more severe damage caused by vibration to the ground wire.

To resolve this problem, vibration dampers, as a key auxiliary apparatus, are widely used in wire systems. By absorbing the vibration energy of the wire, vibration dampers can effectively reduce the amplitude of wire vibration, thereby significantly prolonging the wire's service life. The structure of a vibration damper typically includes a hammer with a certain mass, high-elasticity and high-strength steel strands, and clamps. The vibration dampers are usually suspended on the wires of overhead lines on both sides of the insulators, and fixed to the wires via the clamps. After mounting, the vibration damper can generate motion opposite in phase to the wire's vibration, thereby eliminating or reducing the wire vibration.

The specific working principle of the vibration damper is as follows. When the overhead line vibrates due to wind or other factors, the vibration damper moves up and down, utilizing the inertia of the hammer to cause its steel strand cluster to generate internal friction, thereby consuming most of the vibration energy of the overhead line. The air damping on the hammer consumes a portion of the energy, and the clamp of the vibration damper consumes and reflects another portion of the energy. Thus, according to the principle of energy balance, the energy consumption of the vibration damper reduces the intensity of wind-induced vibration.

Different wire specifications and span lengths can induce different vibration frequencies, and these frequency variations affect the effectiveness of the vibration damper. Various vibration dampers, due to differences in structure, weight, and size, each have a specific natural frequency, and these natural frequencies differ. For example, there are the following types:

The Stockbridge-type vibration damper has a cylindrical hammer cast from pig iron fixed at each end of a high-strength steel strand cluster, with a pair of clamping plates riveted at the middle of the steel strand cluster to facilitate mounting of the vibration damper on the wire. Depending on the structural dimensions of the hammer, it has two natural frequencies.

The multi-frequency vibration damper uses heads of different masses at both ends of the steel strand cluster, with suspension points at unequal distances from the ends of the steel strand cluster. With the use of this structure, four natural frequencies can be obtained, resulting in a wide frequency range. The hammer is a U-shaped structure cast from pig iron to prevent the head from rubbing against the steel strand cluster during high-frequency vibration.

Although the above vibration dampers have multiple natural frequencies, during use, due to the constant variation in vibration characteristics, the vibration damping effect of the damper varies in strength, failing to achieve the optimal vibration damping effect.

In the prior art, for example, a patent No. CN105337235B in the prior art has disclosed an electromagnetic shock-absorbing intelligent vibration damper. When an acceleration sensor detects the initial acceleration direction of a power line vibration, a signal is transmitted to a processor for processing, thereby controlling the on-off state of an electromagnetic coil of an electromagnetic oscillator, such that the magnetic force generated by the electromagnetic coil exceeds the adsorption force of a magnetic ring, adsorbing a cylindrical magnetic mover. The motion of the cylindrical magnetic mover causes the electromagnetic coil to experience an instantaneous reaction force, which in turn causes an annular vibration component to produce motion opposite to the vibration direction. The objective of reducing the vibration is achieved according to the principle: the annular vibration component and the power line are at opposite vibration phases, causing the vibrations to cancel out each other.

However, the above vibration damper requires electrical energy and is powered by solar panels, posing risks of power unavailability during rainy weather, nighttime, or the like, and maintenance of the solar panels is also required, increasing maintenance difficulty for overhead lines.

Additionally, a patent No. CN112952710A in the prior art has disclosed an intelligent wire vibration damper, including a main control unit that detects the vibration frequency and amplitude of a wire and outputs a signal, and a mechanical vibration tuning unit electrically connected to the main control unit and controlled by an output signal of the main control unit to reduce the wire vibration amplitude. The mechanical vibration tuning unit includes a housing connected to the wire, with damping elastic rods provided on two opposite sides of the housing, the two damping elastic rods being parallel and possessing good elasticity. A hammer body is provided at an end of the damping elastic rod away from the housing, and a resonance frequency adjusting nut moves along the length direction of the damping elastic rod, thereby altering a fixture between the hammer body and the frequency adjustment block, allowing the length of the portion of the damping elastic rod that vibrates along with the wire to change. In this way, the vibration of the hammer body can better adapt to different vibration frequencies within a certain range of the wire, thereby more effectively achieving the wire vibration damping effect.

Similarly, this vibration damper is also powered by a solar power supply device, posing risks of power unavailability during rainy weather, nighttime, or the like, and presenting significant maintenance difficulties.

Additionally, a patent No. CN216290112U in the prior art has disclosed an adjustable vibration damper for high-voltage power transmission lines. The vibration damper can be fixed to the required power transmission lines via a fixed hook on a central fixing seat, and rigid extension rods are symmetrically arranged on the left and right sides of the central fixing seat, with a counterweight body individually nested on each rigid extension rod. When the power transmission lines vibrate, it drive the counterweight body and the rigid extension rod to vibrate synchronously, and an inner end of the rigid extension rod is connected to a central adjustment frame via a telescopic sleeve, driving it to move up and down. This allows buffer springs symmetrically arranged above and below a central adjustment frame to absorb the vibration energy, thereby reducing the vibration of the power transmission lines and achieving a vibration damping effect. A pressure adjustment frame provided outside the buffer spring can move to adjust the spacing, thereby adjusting the compression and elasticity of the buffer spring, and further adjusting the overall amplitude and strength of the buffered vibration. This allows for adjustments based on the needs of different power transmission lines, making it more flexible and convenient to use.

However, the above vibration damper uses guide rods to restrict the movement of the head to only up-and-down motion. If the swinging direction of the head is slightly inclined, it may result in unsmooth movement, weakening its vibration damping effect.

Furthermore, the current selection and mounting of vibration dampers mainly rely on the experience of engineers, lacking systematic theoretical support. During selection of the mounting position, counterweight, and energy dissipation frequency of the vibration damper, there is usually no clear calculation basis, which also makes it difficult for conventional design solutions to achieve the optimal vibration damping effect.

### SUMMARY

The technical problem resolved by the present invention is as follows: vibration dampers in the prior art cannot adapt to different vibration frequencies and various environmental conditions.

To resolve the above technical problem, the present disclosure provides a broadband intelligent vibration damper for power transmission lines and an optimization design method therefor. It maximizes the energy absorption and in vibration reduction effects of the vibration damper, fully prolongs the service life of the wire, and provides a reference for the design and mounting of vibration dampers for power transmission wires.

To achieve the foregoing objective, the present disclosure provides the following technical solutions:

The present disclosure provides a broadband intelligent vibration damper for power transmission lines, including a clamp, a steel strand cluster, and two vibration absorbing heads, where the clamp is mounted at a middle portion of the steel strand cluster, and the two vibration absorbing heads are respectively mounted at two ends of the steel strand cluster; the vibration absorbing head comprises a head portion, one end of the head portion is provided with a groove, a bottom surface of the groove is connected to the steel strand cluster, and a bending damper is disposed between the steel strand cluster and a sidewall of the groove; the bending damper has one end connected to the steel strand cluster via a fixing apparatus and the other end connected to the sidewall of the groove of the head portion via an adjusting apparatus; a bending degree of a bending damper can be adjusted via an adjusting apparatus.

A bending damper is disposed inside the head portion, the bending damper being curved. During the swinging process of the head portion, the bending damper bends inward and stretches outward to absorb the vibration energy of the wire transmitted via the steel strand cluster, achieving a vibration damping effect.

The bending degree of the bending damper is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

The clamp is used to grip the wire, thereby mounting the vibration damper on the wire. When the wire experiences breeze vibration, the clamp can transmit the vibration energy to the steel strand cluster and the vibration absorbing heads, achieving energy dissipation and vibration reduction through the friction and bending of the steel strand cluster, as well as the swinging, bending, and friction of the vibration absorbing heads.

In some embodiments, the bending damper comprises an outer spring steel plate, where one end of the outer spring steel plate is connected to the steel strand cluster via a fixing apparatus, and the other end of the outer spring steel plate is connected to a sidewall of the groove of the head portion via an adjusting apparatus. The outer spring steel plate is curved.

In some embodiments, the bending damper further comprises an inner spring steel plate, where the inner spring steel plate is disposed on an inner side of the outer spring steel plate.

In some embodiments, a friction layer is disposed between the outer spring steel plate and the inner spring steel plate.

In some embodiments, the friction layer is a steel sheet.

In some embodiments, the inner surface of the friction layer is a rough surface, and/or the outer surface of the friction layer is a rough surface.

In some embodiments, an inner surface friction coefficient of the friction layer is 0.35-0.45, and/or an outer surface friction coefficient of the friction layer is 0.4-0.5.

In some embodiments, the bending damper further comprises a first limiter, where the first limiter is disposed on an inner side of an end head of the outer spring steel plate connected to the adjusting apparatus.

In some embodiments, the bending damper further comprises a second limiter, where the second limiter is disposed on an inner side of a joint between the outer spring steel plate and the fixing apparatus.

In some embodiments, the fixing apparatus is a connecting block.

In some embodiments, the bending damper is rigidly connected to the fixing apparatus.

In some embodiments, the adjusting apparatus comprises an adjusting bolt and an adjusting nut, where the adjusting bolt is disposed on the sidewall of the groove of the head portion, and one end of the bending damper sleeves the adjusting bolt. The adjusting nut is disposed on the adjusting bolt, and the adjusting nut is located between an end head of the bending damper and the sidewall of the groove.

In some embodiments, the adjusting apparatus further comprises an adjusting spring, the adjusting spring sleeves the adjusting bolt, one end of the adjusting spring abuts against the sidewall of the groove, and the other end of the adjusting spring abuts against the adjusting nut.

In some embodiments, the adjusting apparatus further comprises a protective nut, where the protective nut is disposed on an outer side of the end head of the bending damper.

In some embodiments, the outer wall of the head portion is provided with a counterweight slot. The counterweight can be added via the counterweight slot to adjust the weight of the head portion.

In some embodiments, the vibration absorbing head further comprises a ball joint, where the ball joint is disposed on a bottom wall of the groove for connecting to the steel strand cluster.

In some embodiments, two bending dampers are provided, and the two bending dampers are symmetrically disposed on two sides of the steel strand cluster.

In some embodiments, the head portion is cylindrical, and the groove is arranged along an axis of the head portion.

In some embodiments, an end of the head portion away from the groove is a spherical curved surface.

In some embodiments, a miniature acceleration sensor is disposed at the top of the spherical curved surface of the end of the head portion away from the groove.

In some embodiments, the acceleration sensor employs MEMS (Micro-Electro-Mechanical Systems) technology for self-powering, requiring no external power source.

In some embodiments, a signal from the acceleration sensor can be transmitted via a wireless communication module mounted on a transmission tower, where the wireless transmission module is powered by a solar panel.

In some embodiments, the steel strand cluster includes an upper steel strand, where the upper steel strand is connected to the vibration absorbing head.

In some embodiments, the upper steel strand is connected to the ball joint of the vibration absorbing head.

In some embodiments, two upper steel strands are provided, and the two upper steel strands are horizontally arranged in parallel.

In some embodiments, the steel strand cluster further includes a lower steel strand and a steel wire, where the lower steel strand is disposed below the upper steel strand, and two ends of the lower steel strand are free ends. The steel wire is wound around outer sides of the lower steel strand and the upper steel strand.

In some embodiments, the lower steel strand and the two upper steel strands form an inverted triangular structure.

In some embodiments, the length of the lower steel strand is less than the length of the upper steel strand.

In some embodiments, the clamp includes an annular tentacle, an independent tentacle, and a conductor, where a bottom end of the conductor is connected to the middle portion of the steel strand cluster, an upper end of the conductor is connected to the annular tentacle, the annular tentacle is detachably connected to the independent tentacle, and a wire is disposed between the annular tentacle and the independent tentacle.

In some embodiments, the annular tentacle includes a first clamping jaw at an upper side and a first connecting plate below the first clamping jaw, where the first clamping jaw is configured to clamp the wire, and the first connecting plate is connected to the conductor.

In some embodiments, the cross-section of the first clamping jaw is a semicircular ring.

In some embodiments, the first connecting plate is in an inverted trapezoidal shape.

In some embodiments, the independent tentacle includes a second clamping jaw at an upper side and a second connecting plate below the second clamping jaw, where the second clamping jaw is configured to clamp the wire, and the second connecting plate is detachably connected to the first connecting plate.

In some embodiments, the independent tentacle includes a second clamping jaw at an upper side and a second connecting plate below the second clamping jaw, where the second clamping jaw is configured to clamp the wire, and the second connecting plate is detachably connected to the first connecting plate.

In some embodiments, a lever block is disposed at a bottom between the first connecting plate and the second connecting plate.

In some embodiments, the lever block is welded to the first connecting plate.

In some embodiments, the conductor includes a transition block and a steel strand block below the transition block, where an upper part of the transition block is connected to the annular tentacle, a through hole is arranged inside the steel strand block, and the steel strand block is fixedly connected to the steel strand cluster via the through hole therein.

In some embodiments, when the vibration damper is mounted on the wire, a posture of the vibration absorbing head satisfies that the bending dampers on two sides of the steel strand cluster are arranged vertically.

As compared with the prior art, the vibration damper provided by the present disclosure has the following beneficial effects.

1. The broadband intelligent vibration damper provided by the present disclosure includes a bending damper disposed inside the head portion, where one end of the bending damper is connected to the steel strand, and the other end is connected to the head portion via an adjusting apparatus. During the swinging process of the head portion, the bending damper is continuously compressed and stretched, serving the objective of absorbing vibration and dissipating energy. The bending degree of the bending damper can be adjusted via the adjusting apparatus, enabling free adjustment of the frequency of the bending damper, thus allowing the vibration absorbing head to adapt to different vibration frequencies and various environmental conditions. Moreover, the bending damper is not specifically limited in its stretching direction. Even if a swinging direction of a head portion is inclined, the bending and stretching of the bending damper are not affected, meaning its vibration damping effect is not affected. The acceleration sensor can monitor the vibration condition of the head portion, indirectly monitoring the load-bearing state of the wire.

2. The broadband intelligent vibration damper provided by the present disclosure has its internally disposed bending damper designed with an outer spring steel plate and an inner spring steel plate. As the outer spring steel plate continuously bends, it drives the inner spring steel plate to constantly shift, achieving friction-based energy dissipation.

3. The broadband intelligent vibration damper provided by the present disclosure includes a friction layer disposed between the outer spring steel plate and the inner spring steel plate, increasing the friction area. Additionally, the surface of the friction layer is a rough surface, further increasing friction and improving friction-based energy dissipation efficiency.

4. The broadband intelligent vibration damper provided by the present disclosure includes an adjusting spring disposed between the adjusting nut and the sidewall of the groove. The rebound force of the adjusting spring is used for pressing against the adjusting nut, preventing the adjusting nut from loosening, thereby avoiding frequency changes in the vibration absorbing head during use and effectively ensuring a consistently stable vibration damping effect.

5. The broadband intelligent vibration damper provided by the present disclosure is provided with a counterweight slot on the outer wall of the head portion, allowing the counterweight to be added as needed, and providing more options for frequency adjustment.

6. According to the broadband intelligent vibration damper provided by the present disclosure, the clamp is used to grip the wire, thereby mounting the vibration damper on the wire. The steel strand cluster is connected below the clamp, with the vibration absorbing heads provided by the present disclosure disposed on two sides of the steel strand cluster. Based on the feature of the vibration absorbing head freely adjusting the frequency, the vibration damper provided by the present disclosure can adapt to wires with different vibration frequencies and various environmental conditions.

7. According to the broadband intelligent vibration damper provided by the present disclosure, the steel strand cluster is used to connect the clamp and the vibration absorbing head, where the steel strand cluster comprises two upper steel strands and one lower steel strand. During wire vibration, the steel strands rub against each other, through the principle of friction-based energy dissipation, to further enhance the vibration reduction and damping effect of the vibration damper. Moreover, the steel strand cluster in the present disclosure increases the friction area and adjustability between the steel strands. The increased friction area provides greater energy dissipation capacity, with two ends of the lower steel strand being free ends. This facilitates replacement of the lower steel strand without disassembling the head portion, thereby providing greater convenience and operability for frequency adjustment of the vibration damper. This also facilitates the maintenance of the vibration damper.

8. The broadband intelligent vibration damper provided by the present disclosure has a clamp that includes an annular tentacle and an independent tentacle, with a lever block disposed between the annular tentacle and the independent tentacle. The lever block creates a certain gap between the annular tentacle and the independent tentacle, and fastening bolts are used to secure the annular tentacle and the independent tentacle, enabling the annular tentacle to firmly grip the clamp and generate a preload force to effectively transmit vibration energy, and allowing the wire to be gripped still tightly even when the wire diameter is reduced.

The present disclosure also provides an optimization design method for broadband intelligent vibration damper, optimizing the design of the forgoing broadband intelligent vibration damper. The method includes:
S1: measuring a vibration angle αₘ and a maximum vibration frequency f at a wire hanging position of the power transmission lines;
S2: setting a frequency of one of the vibration absorbing heads to a first set value, setting a frequency of the other vibration absorbing head to a second set value, and setting an overall frequency of the vibration damper to a third set value without considering vibration of the vibration absorbing heads; and
S3: re-measuring the vibration angle at the wire hanging position after the vibration damper is mounted, and completing the mounting when a re-measured vibration angle is less than an allowable vibration angle; wherein when a maximum vibration angle exceeds the allowable vibration angle, counterweight should be added with the frequency of the vibration damper kept unchanged, and re-measuring is performed until the maximum vibration angle is less than the allowable vibration angle to complete mounting.

In some embodiments, the vibration angle αₘ satisfies:

$${α}_{m} = {tan}^{- 1} ( \frac{2 π {C}_{1}}{μ sin \frac{2 π l}{μ}} ) ;$$

where μ represents a vibration wave wavelength, C₁ represents an amplitude of a vibration wave at a measurement point, and l represents a distance between the measurement point and an entrance of the clamp.

In some embodiments, the maximum vibration frequency f satisfies:

$$f = \frac{1}{2 π} \sqrt{\frac{k}{m}} ;$$

where k represents a stiffness of the wire system, and m represents the wire mass.

In some embodiments, the first set value is 0.1 f.

In some embodiments, the second set value is 0.5 f.

In some embodiments, the third set value is 0.8 f.

In some embodiments, re-measuring the vibration angle at the wire hanging position specifically includes: after the vibration damper is mounted, the vibration angle is measured at least once or more, and the maximum value is taken as the re-measured vibration angle.

In some embodiments, the allowable vibration angle is 10′.

In some embodiments, in step S3, the addition of the counterweight with the frequency of the vibration damper kept unchanged specifically includes: adding one counterweight block with a mass of 50 g each time, and adjusting a position of the adjusting nut after the counterweight addition, to ensure the unchanged frequency of the vibration damper.

Compared with the prior art, the optimization design method for vibration damper provided by the present disclosure has the following beneficial effects. First, the maximum vibration frequency and vibration angle of the wire near the hanging position are measured, and the natural frequencies of the two vibration absorbing heads and the overall vibration damper are adjusted to 0.1 f, 0.5 f, and 0.8 f. Then, after the frequency of the vibration damper is kept unchanged based on the counterweight, the vibration angle is re-measured to ensure the maximum vibration angle is less than the allowable vibration angle, thereby maximizing the vibration reduction and energy absorption effect.

### BRIEF DESCRIPTION OF THE DRAWINGS

To more clearly illustrate the technical solutions in the embodiments of the present disclosure or in the prior art, a brief description of the drawings required in the description of the embodiments or the prior art is provided below.

FIG. 1 is a schematic structural diagram of a vibration absorbing head according to some embodiments.

FIG. 2 is a schematic structural diagram of a bending damper according to some embodiments.

FIG. 3 is a schematic structural three-dimensional diagram of a vibration damper according to some embodiments.

FIG. 4 is a front view of a vibration damper according to some embodiments, where a portion of an annular tentacle is cut away to facilitate the display of an independent tentacle.

FIG. 5 is a schematic cross-sectional view of a steel strand cluster according to some embodiments.

FIG. 6 is a schematic structural diagram of a clamp according to some embodiments.

FIG. 7 is an exploded view of a clamp according to some embodiments.

### DESCRIPTION OF REFERENCE NUMERALS IN THE FIGURES

1. Clamp; 1-1. Annular tentacle; 1-2. Independent tentacle; 1-3. Fastening bolt; 1-4. Lever block; 1-5. Conductor;
2. Steel strand cluster; 2-1. Upper steel strand; 2-2. Lower steel strand; 2-3. Steel wire;
3. Vibration absorbing head; 3-1. Head portion; 3-2. Counterweight slot; 3-3. Ball joint; 3-4. Fixing apparatus; 3-5. Adjusting bolt; 3-6. Outer spring steel plate; 3-7. Adjusting nut; 3-8. Protective nut; 3-9. Second limiter; 3-10. Friction layer; 3-11. Inner spring steel plate; 3-12. Adjusting spring.

### DETAILED DESCRIPTION OF THE EMBODIMENTS

The technical solutions of the present disclosure will be clearly described below with reference to the accompanying drawings. Obviously, the described embodiments are not all embodiments of the present disclosure, and all other embodiments obtained by those of ordinary skill in the art without creative effort fall within the protection scope of the present disclosure.

It should be noted that, unless specifically stated otherwise, the relative arrangement of components and steps and numerical expressions set forth in these embodiments should not be construed as limiting the scope of the present disclosure.

The following description of exemplary embodiments is merely illustrative and is not intended, in any sense, as any limitation on the present disclosure, its applications, or its uses.

It should be noted that the terms used herein are only for describing specific implementations and are not intended to limit the exemplary implementations according to the present application. As used herein, unless the context clearly indicates otherwise, the singular form is also intended to include the plural form. Furthermore, it should be understood that when the terms “comprise” and/or “include” are used in this specification, they indicate the presence of features, steps, operations, devices, components, and/or combinations thereof.

For convenience of description, the terms “upper,” “lower,” “left,” and “right” appear in the present disclosure but do not limit the structure; they are merely used to facilitate the description of the present disclosure and simplify the description, rather than to indicate or imply that the referred devices or elements must have a specific orientation, be constructed, or operate in a specific orientation, and thus should not be construed as limiting the present disclosure.

Terminology explanation section. Terms such as “mounted,” “connected,” “connection,” and “fixed” in the present disclosure should be understood in a broad sense. Those of ordinary skill in the art can understand the specific meanings of the above terms in the present disclosure based on specific circumstances.

### Embodiment 1

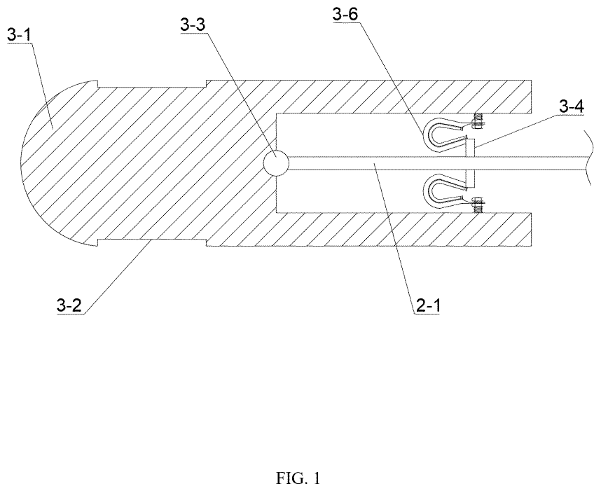

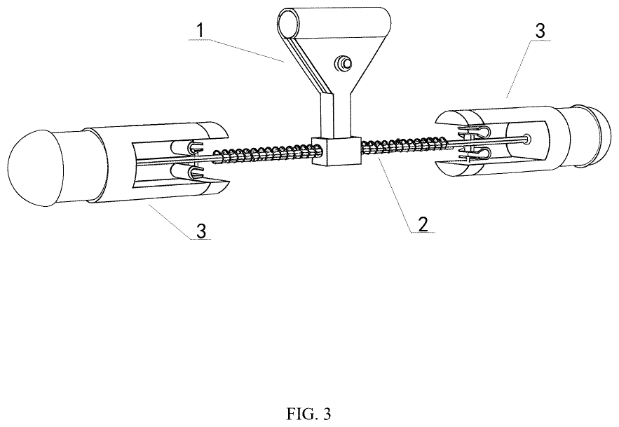

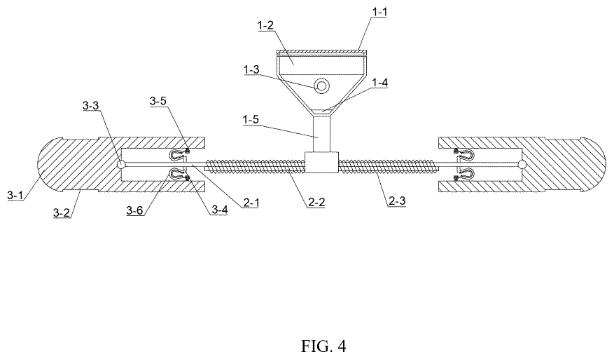

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

A bending damper is disposed inside the head portion 3-1, the bending damper being curved. During the swinging process of the head portion 3-1, the bending damper bends inward and stretches outward to absorb the vibration energy of the wire transmitted via the steel strand cluster, achieving a vibration damping effect.

The bending degree of the bending damper is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

The groove refers to a groove recessed on the surface of one end of the head portion 3-1, and the shape of the slot may be square, circular, polygonal, or of other shapes. Taking FIG. 1 as an example, the groove is U-shaped, where the bottom surface of the groove refers to the vertical wall surface, and the sidewall of the groove refers to the horizontal wall surface.

Additionally, the steel strand cluster 2 may alternatively be replaced with a steel strand or other connecting components used to connect the clamp and the vibration absorbing head, such as a steel wire rope. Such equivalent replacements of the steel strand cluster 2 still fall within the protection scope of this embodiment.

The clamp 1 is used to grip the wire, thereby mounting the vibration damper on the wire. When the wire experiences breeze vibration, the clamp 1 can transmit the vibration energy to the steel strand cluster 2 and the vibration absorbing heads 3, achieving energy dissipation and vibration reduction through the friction and bending of the steel strand cluster 2, as well as the swinging, bending, and friction of the vibration absorbing heads 3.

### Embodiment 2

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

A bending damper is disposed inside the head portion 3-1, the bending damper being curved. During the swinging process of the head portion 3-1, the bending damper bends inward and stretches outward to absorb the vibration energy of the wire transmitted via the steel strand cluster, achieving a vibration damping effect.

The bending degree of the bending damper is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

The groove refers to a groove recessed on the surface of one end of the head portion 3-1, and the shape of the slot may be square, circular, polygonal, or of other shapes. Taking FIG. 1 as an example, the groove is U-shaped, where the bottom surface of the groove refers to the vertical wall surface, and the sidewall of the groove refers to the horizontal wall surface.

Additionally, the steel strand cluster 2 may alternatively be replaced with a steel strand or other connecting components used to connect the clamp and the vibration absorbing head, such as a steel wire rope. Such equivalent replacements of the steel strand cluster 2 still fall within the protection scope of this embodiment.

The clamp 1 is used to grip the wire, thereby mounting the vibration damper on the wire. When the wire experiences breeze vibration, the clamp 1 can transmit the vibration energy to the steel strand cluster 2 and the vibration absorbing heads 3, achieving energy dissipation and vibration reduction through the friction and bending of the steel strand cluster 2, as well as the swinging, bending, and friction of the vibration absorbing heads 3.

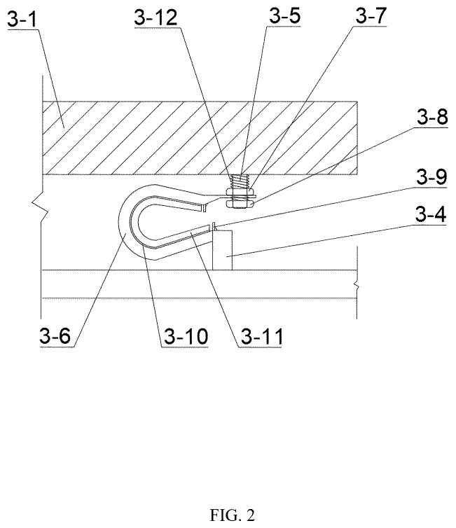

As shown in FIG. 2, the bending damper includes an outer spring steel plate 3-6, where one end of the outer spring steel plate 3-6 is connected to the steel strand via a fixing apparatus 3-4, and the other end of the outer spring steel plate 3-6 is connected to the sidewall of the groove of the head portion 3-1 via an adjusting apparatus. The outer spring steel plate 3-6 is curved.

The outer spring steel plate 3-6 itself is a plate-shaped piece; it is bent into a curved shape using the fixing apparatus 3-4 and the adjusting apparatus and then mounted between the steel strand cluster and the sidewall of the groove of the head portion 3-1. Thus, the outer spring steel plate 3-6 has a tendency to stretch and also has a certain compression space. During the swinging process of the head portion 3-1, the outer spring steel plate 3-6 bends inward and stretches outward to absorb the vibration energy of the wire transmitted via the steel strand, achieving a vibration damping effect.

Additionally, a miniature acceleration sensor is disposed at the top of the spherical curved surface of one end of the head portion 3-1, and the vibration characteristics of the head portion 3-1 are influenced by the vibration characteristics of the wire. The acceleration sensor employs MEMS (Micro-Electro-Mechanical Systems) technology for self-powering, requiring no external power source. Moreover, the signal from the acceleration sensor can be transmitted via a wireless communication module mounted on a transmission tower, where the wireless transmission module is powered by a solar panel. Thus, the performance state of the wire can be monitored by monitoring the acceleration of the head portion, enabling rapid identification of wires with fatigue-induced strand breakage.

### Embodiment 3

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

As shown in FIG. 2, the bending damper includes an outer spring steel plate 3-6, where one end of the outer spring steel plate 3-6 is connected to the steel strand via a fixing apparatus 3-4, and the other end of the outer spring steel plate 3-6 is connected to the sidewall of the groove of the head portion 3-1 via an adjusting apparatus. The outer spring steel plate 3-6 is curved.

The outer spring steel plate 3-6 itself is a plate-shaped piece; it is bent into a curved shape using the fixing apparatus 3-4 and the adjusting apparatus and then mounted between the steel strand cluster and the sidewall of the groove of the head portion 3-1. Thus, the outer spring steel plate 3-6 has a tendency to stretch and also has a certain compression space. During the swinging process of the head portion 3-1, the outer spring steel plate 3-6 bends inward and stretches outward to absorb the vibration energy of the wire transmitted via the steel strand, achieving a vibration damping effect.

The bending degree of the bending damper is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

The groove refers to a groove recessed on the surface of one end of the head portion 3-1, and the shape of the slot may be square, circular, polygonal, or of other shapes. Taking FIG. 1 as an example, the groove is U-shaped, where the bottom surface of the groove refers to the vertical wall surface, and the sidewall of the groove refers to the horizontal wall surface.

Additionally, the steel strand cluster 2 may alternatively be replaced with a steel strand or other connecting components used to connect the clamp and the vibration absorbing head, such as a steel wire rope. Such equivalent replacements of the steel strand cluster 2 still fall within the protection scope of this embodiment.

The clamp 1 is used to grip the wire, thereby mounting the vibration damper on the wire. When the wire experiences breeze vibration, the clamp 1 can transmit the vibration energy to the steel strand cluster 2 and the vibration absorbing heads 3, achieving energy dissipation and vibration reduction through the friction and bending of the steel strand cluster 2, as well as the swinging, bending, and friction of the vibration absorbing heads 3.

As shown in FIG. 2, the bending damper further includes an inner spring steel plate 3-11, where the inner spring steel plate 3-11 is disposed on an inner side of the outer spring steel plate 3-6.

A friction layer 3-10 is disposed between the outer spring steel plate 3-6 and the inner spring steel plate 3-11. The friction layer 3-10 is a steel sheet. The inner surface of the friction layer 3-10 is a rough surface, and/or the outer surface of the friction layer 3-10 is a rough surface. In this embodiment, both the inner surface and the outer surface of the friction layer 3-10 are rough surfaces.

The inner surface friction coefficient of the friction layer 3-10 is 0.35, and the outer surface friction coefficient of the friction layer 3-10 is 0.4.

The inner spring steel plate 3-11 and the friction layer 3-10 are not fixedly connected to the outer spring steel plate 3-6. Rather, the inner spring steel plate 3-11 and the friction layer 3-10 are merely placed on the inner side of the outer spring steel plate 3-6, and neither the inner spring steel plate 3-11 nor the friction layer 3-10 is fixedly connected to other components. Thus, the friction layer 3-10 and the outer spring steel plate 3-6 can slide relative to each other, and the inner spring steel plate 3-11 and the friction layer 3-10 can slide relative to each other. The inner spring steel plate 3-11 and the friction layer 3-10 are both plate-shaped pieces. After being placed in the curved space of the outer spring steel plate 3-6, both the inner spring steel plate 3-11 and the friction layer 3-10 bend. Thus, both the inner spring steel plate 3-11 and the friction layer 3-10 have a tendency to stretch outward, allowing the friction layer 3-10 to closely adhere to the outer spring steel plate 3-6 and the inner spring steel plate 3-11 to closely adhere to the friction layer 3-10.

During the swinging process of the head portion 3-1, the outer spring steel plate 3-6 is continuously compressed and stretched, driving the friction layer 3-10 and the inner spring steel plate 3-11 to continuously compress and stretch. This results in continuous relative movement between the friction layer 3-10 and the outer spring steel plate 3-6, and between the friction layer 3-10 and the inner spring steel plate 3-11, achieving friction-based energy dissipation.

The friction layer 3-10 can increase the friction area, and the surface of the friction layer 3-10 is a rough surface, further increasing friction, thus improving friction-based energy dissipation efficiency.

### Embodiment 4

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

The clamp 1 is used to grip the wire, thereby mounting the vibration damper on the wire. When the wire experiences breeze vibration, the clamp 1 can transmit the vibration energy to the steel strand cluster 2 and the vibration absorbing heads 3, achieving energy dissipation and vibration reduction through the friction and bending of the steel strand cluster 2, as well as the swinging, bending, and friction of the vibration absorbing heads 3.

As shown in FIG. 2, the bending damper includes an outer spring steel plate 3-6, where one end of the outer spring steel plate 3-6 is connected to the steel strand via a fixing apparatus 3-4, and the other end of the outer spring steel plate 3-6 is connected to the sidewall of the groove of the head portion 3-1 via an adjusting apparatus. The outer spring steel plate 3-6 is curved.

The outer spring steel plate 3-6 itself is a plate-shaped piece; it is bent into a curved shape using the fixing apparatus 3-4 and the adjusting apparatus and then mounted between the steel strand cluster and the sidewall of the groove of the head portion 3-1. Thus, the outer spring steel plate 3-6 has a tendency to stretch and also has a certain compression space. During the swinging process of the head portion 3-1, the outer spring steel plate 3-6 bends inward and stretches outward to absorb the vibration energy of the wire transmitted via the steel strand, achieving a vibration damping effect.

The bending degree of the outer spring steel plate 3-6 is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

The groove refers to a groove recessed on the surface of one end of the head portion 3-1, and the shape of the slot may be square, circular, polygonal, or of other shapes. Taking FIG. 1 as an example, the groove is U-shaped, where the bottom surface of the groove refers to the vertical wall surface, and the sidewall of the groove refers to the horizontal wall surface.

Additionally, it can be understood that the steel strand cluster 2 may alternatively be replaced with a steel strand or other connecting components used to connect the clamp and the vibration absorbing head, such as a steel wire rope. Such equivalent replacements of the steel strand cluster 2 still fall within the protection scope of this embodiment.

As shown in FIG. 2, the bending damper further includes an inner spring steel plate 3-11, where the inner spring steel plate 3-11 is disposed on an inner side of the outer spring steel plate 3-6.

A friction layer 3-10 is disposed between the outer spring steel plate 3-6 and the inner spring steel plate 3-11. The friction layer 3-10 is a steel sheet. The inner surface of the friction layer 3-10 is a rough surface, and/or the outer surface of the friction layer 3-10 is a rough surface. In this embodiment, both the inner surface and the outer surface of the friction layer 3-10 are rough surfaces.

The inner surface friction coefficient of the friction layer 3-10 is 0.45, and the outer surface friction coefficient of the friction layer 3-10 is 0.5.

The inner spring steel plate 3-11 and the friction layer 3-10 are not fixedly connected to the outer spring steel plate 3-6. Rather, the inner spring steel plate 3-11 and the friction layer 3-10 are merely placed on the inner side of the outer spring steel plate 3-6, and neither the inner spring steel plate 3-11 nor the friction layer 3-10 is fixedly connected to other components. Thus, the friction layer 3-10 and the outer spring steel plate 3-6 can slide relative to each other, and the inner spring steel plate 3-11 and the friction layer 3-10 can slide relative to each other. The inner spring steel plate 3-11 and the friction layer 3-10 are both plate-shaped pieces. After being placed in the curved space of the outer spring steel plate 3-6, both the inner spring steel plate 3-11 and the friction layer 3-10 bend. Thus, both the inner spring steel plate 3-11 and the friction layer 3-10 have a tendency to stretch outward, allowing the friction layer 3-10 to closely adhere to the outer spring steel plate 3-6 and the inner spring steel plate 3-11 to closely adhere to the friction layer 3-10.

During the swinging process of the head portion 3-1, the outer spring steel plate 3-6 is continuously compressed and stretched, driving the friction layer 3-10 and the inner spring steel plate 3-11 to continuously compress and stretch. This results in continuous relative movement between the friction layer 3-10 and the outer spring steel plate 3-6, and between the friction layer 3-10 and the inner spring steel plate 3-11, achieving friction-based energy dissipation.

The friction layer 3-10 can increase the friction area, and the surface of the friction layer 3-10 is a rough surface, further increasing friction, thus improving friction-based energy dissipation efficiency.

### Embodiment 5

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

The groove refers to a groove recessed on the surface of one end of the head portion 3-1, and the shape of the slot may be square, circular, polygonal, or of other shapes. Taking FIG. 1 as an example, the groove is U-shaped, where the bottom surface of the groove refers to the vertical wall surface, and the sidewall of the groove refers to the horizontal wall surface.

Additionally, it can be understood that the steel strand cluster 2 may alternatively be replaced with a steel strand or other connecting components used to connect the clamp and the vibration absorbing head, such as a steel wire rope. Such equivalent replacements of the steel strand cluster 2 still fall within the protection scope of this embodiment.

As shown in FIG. 2, the bending damper includes an outer spring steel plate 3-6, where one end of the outer spring steel plate 3-6 is connected to the steel strand via a fixing apparatus 3-4, and the other end of the outer spring steel plate 3-6 is connected to the sidewall of the groove of the head portion 3-1 via an adjusting apparatus. The outer spring steel plate 3-6 is curved.

As shown in FIG. 2, the bending damper further includes an inner spring steel plate 3-11, where the inner spring steel plate 3-11 is disposed on an inner side of the outer spring steel plate 3-6.

A friction layer 3-10 is disposed between the outer spring steel plate 3-6 and the inner spring steel plate 3-11. The friction layer 3-10 is a steel sheet. The inner surface of the friction layer 3-10 is a rough surface, and/or the outer surface of the friction layer 3-10 is a rough surface. In this embodiment, both the inner surface and the outer surface of the friction layer 3-10 are rough surfaces.

The inner surface friction coefficient of the friction layer 3-10 is 0.4, and the outer surface friction coefficient of the friction layer 3-10 is 0.45.

The inner spring steel plate 3-11 and the friction layer 3-10 are not fixedly connected to the outer spring steel plate 3-6. Rather, the inner spring steel plate 3-11 and the friction layer 3-10 are merely placed on the inner side of the outer spring steel plate 3-6, and neither the inner spring steel plate 3-11 nor the friction layer 3-10 is fixedly connected to other components. Thus, the friction layer 3-10 and the outer spring steel plate 3-6 can slide relative to each other, and the inner spring steel plate 3-11 and the friction layer 3-10 can slide relative to each other. The inner spring steel plate 3-11 and the friction layer 3-10 are both plate-shaped pieces. After being placed in the curved space of the outer spring steel plate 3-6, both the inner spring steel plate 3-11 and the friction layer 3-10 bend. Thus, both the inner spring steel plate 3-11 and the friction layer 3-10 have a tendency to stretch outward, allowing the friction layer 3-10 to closely adhere to the outer spring steel plate 3-6 and the inner spring steel plate 3-11 to closely adhere to the friction layer 3-10.

The outer spring steel plate 3-6 itself is a plate-shaped piece; it is bent into a curved shape using the fixing apparatus 3-4 and the adjusting apparatus and then mounted between the steel strand cluster and the sidewall of the groove of the head portion 3-1. Thus, the outer spring steel plate 3-6 has a tendency to stretch and also has a certain compression space. During the swinging process of the head portion 3-1, the outer spring steel plate 3-6 bends inward and stretches outward to absorb the vibration energy of the wire transmitted via the steel strand, achieving a vibration damping effect.

The bending degree of the outer spring steel plate 3-6 is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

During the swinging process of the head portion 3-1, the outer spring steel plate 3-6 is continuously compressed and stretched, driving the friction layer 3-10 and the inner spring steel plate 3-11 to continuously compress and stretch. This results in continuous relative movement between the friction layer 3-10 and the outer spring steel plate 3-6, and between the friction layer 3-10 and the inner spring steel plate 3-11, achieving friction-based energy dissipation.

The friction layer 3-10 can increase the friction area, and the surface of the friction layer 3-10 is a rough surface, further increasing friction, thus improving friction-based energy dissipation efficiency.

Based on the above technical solution, as shown in FIG. 2, the bending damper further includes a first limiter, where the first limiter is disposed on an inner side of an end head of the outer spring steel plate 3-6 connected to the adjusting apparatus. The bending damper further includes a second limiter 3-9, where the second limiter 3-9 is disposed on an inner side of a joint between the outer spring steel plate 3-6 and the fixing apparatus 3-4.

The structures of the first limiter and the second limiter 3-9 may be the same or different. In this embodiment, the first limiter and the second limiter 3-9 have the same structure, both being vertically arranged plates with reinforcing ribs provided on the rear side of the plates. The first limiter and the second limiter 3-9 are used to prevent the inner spring steel plate 3-11 and the friction layer 3-10 from escaping from the outer spring steel plate 3-6. This design serves as a defensive mechanism, and under normal circumstances, the inner spring steel plate 3-11 and the friction layer 3-10 do not escape from the outer spring steel plate 3-6.

Additionally, since the outer spring steel plate 3-6 has a certain length, and during the use of the vibration absorbing head, both the friction layer 3-10 and the inner spring steel plate 3-11 are curved, the friction between the friction layer 3-10 and the outer spring steel plate 3-6 can prevent the friction layer 3-10 from falling off the side of the outer spring steel plate 3-6, and the friction between the inner spring steel plate 3-11 and the friction layer 3-10 can prevent the inner spring steel plate 3-11 from falling off the side of the friction layer 3-10. Therefore, no limiting structures are needed on the sides of the friction layer 3-10 and the inner spring steel plate 3-11.

### Embodiment 6

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

The groove refers to a groove recessed on the surface of one end of the head portion 3-1, and the shape of the slot may be square, circular, polygonal, or of other shapes. Taking FIG. 1 as an example, the groove is U-shaped, where the bottom surface of the groove refers to the vertical wall surface, and the sidewall of the groove refers to the horizontal wall surface.

Additionally, it can be understood that the steel strand cluster 2 may alternatively be replaced with a steel strand or other connecting components used to connect the clamp and the vibration absorbing head, such as a steel wire rope. Such equivalent replacements of the steel strand cluster 2 still fall within the protection scope of this embodiment.

As shown in FIG. 2, the bending damper includes an outer spring steel plate 3-6, where one end of the outer spring steel plate 3-6 is connected to the steel strand via a fixing apparatus 3-4, and the other end of the outer spring steel plate 3-6 is connected to the sidewall of the groove of the head portion 3-1 via an adjusting apparatus. The outer spring steel plate 3-6 is curved.

The bending damper further includes an inner spring steel plate 3-11, where the inner spring steel plate 3-11 is disposed on an inner side of the outer spring steel plate 3-6.

A friction layer 3-10 is disposed between the outer spring steel plate 3-6 and the inner spring steel plate 3-11. The friction layer 3-10 is a steel sheet. The inner surface of the friction layer 3-10 is a rough surface, and/or the outer surface of the friction layer 3-10 is a rough surface. In this embodiment, both the inner surface and the outer surface of the friction layer 3-10 are rough surfaces.

The inner surface friction coefficient of the friction layer 3-10 is 0.45, and the outer surface friction coefficient of the friction layer 3-10 is 0.4.

The inner spring steel plate 3-11 and the friction layer 3-10 are not fixedly connected to the outer spring steel plate 3-6. Rather, the inner spring steel plate 3-11 and the friction layer 3-10 are merely placed on the inner side of the outer spring steel plate 3-6, and neither the inner spring steel plate 3-11 nor the friction layer 3-10 is fixedly connected to other components. Thus, the friction layer 3-10 and the outer spring steel plate 3-6 can slide relative to each other, and the inner spring steel plate 3-11 and the friction layer 3-10 can slide relative to each other. The inner spring steel plate 3-11 and the friction layer 3-10 are both plate-shaped pieces. After being placed in the curved space of the outer spring steel plate 3-6, both the inner spring steel plate 3-11 and the friction layer 3-10 bend. Thus, both the inner spring steel plate 3-11 and the friction layer 3-10 have a tendency to stretch outward, allowing the friction layer 3-10 to closely adhere to the outer spring steel plate 3-6 and the inner spring steel plate 3-11 to closely adhere to the friction layer 3-10.

The outer spring steel plate 3-6 itself is a plate-shaped piece; it is bent into a curved shape using the fixing apparatus 3-4 and the adjusting apparatus and then mounted between the steel strand cluster and the sidewall of the groove of the head portion 3-1. Thus, the outer spring steel plate 3-6 has a tendency to stretch and also has a certain compression space. During the swinging process of the head portion 3-1, the outer spring steel plate 3-6 bends inward and stretches outward to absorb the vibration energy of the wire transmitted via the steel strand, achieving a vibration damping effect.

The bending degree of the outer spring steel plate 3-6 is adjusted via the adjusting apparatus, thereby adjusting the vibration frequency of the bending damper, enabling the vibration absorbing head to have more resonance frequencies and a wider damping frequency band, and resulting in a better vibration absorption and suppression effect.

During the swinging process of the head portion 3-1, the outer spring steel plate 3-6 is continuously compressed and stretched, driving the friction layer 3-10 and the inner spring steel plate 3-11 to continuously compress and stretch. This results in continuous relative movement between the friction layer 3-10 and the outer spring steel plate 3-6, and between the friction layer 3-10 and the inner spring steel plate 3-11, achieving friction-based energy dissipation.

The friction layer 3-10 can increase the friction area, and the surface of the friction layer 3-10 is a rough surface, further increasing friction, thus improving friction-based energy dissipation efficiency.

As shown in FIG. 2, the bending damper further includes a first limiter, where the first limiter is disposed on an inner side of an end head of the outer spring steel plate 3-6 connected to the adjusting apparatus. The bending damper further includes a second limiter 3-9, where the second limiter 3-9 is disposed on an inner side of a joint between the outer spring steel plate 3-6 and the fixing apparatus 3-4.

The structures of the first limiter and the second limiter 3-9 may be the same or different. In this embodiment, the first limiter and the second limiter 3-9 have the same structure, both being vertically arranged plates with reinforcing ribs provided on the rear side of the plates. The first limiter and the second limiter 3-9 are used to prevent the inner spring steel plate 3-11 and the friction layer 3-10 from escaping from the outer spring steel plate 3-6. This design serves as a defensive mechanism, and under normal circumstances, the inner spring steel plate 3-11 and the friction layer 3-10 do not escape from the outer spring steel plate 3-6.

Additionally, since the outer spring steel plate 3-6 has a certain length, and during the use of the vibration absorbing head 3, both the friction layer 3-10 and the inner spring steel plate 3-11 are curved, the friction between the friction layer 3-10 and the outer spring steel plate 3-6 can prevent the friction layer 3-10 from falling off the side of the outer spring steel plate 3-6, and the friction between the inner spring steel plate 3-11 and the friction layer 3-10 can prevent the inner spring steel plate 3-11 from falling off the side of the friction layer 3-10. Therefore, no limiting structures are needed on the sides of the friction layer 3-10 and the inner spring steel plate 3-11.

Based on the above technical solution, as shown in FIG. 2, the specific structure of the fixing apparatus 3-4 is a connecting block. The outer spring steel plate 3-6 is rigidly connected to the fixing apparatus 3-4. The rigid connection may be welding, riveting, crimping, or other connection methods. In this embodiment, welding is preferred. The connecting block is arranged nearly perpendicular to the steel strand cluster. It can be understood that the connecting block may alternatively be connected to the steel strand at other inclined angles without affecting the energy dissipation function of the bending damper.

The adjusting apparatus includes an adjusting bolt 3-5 and an adjusting nut 3-7, where the adjusting bolt 3-5 is disposed on the sidewall of the groove of the head portion 3-1, and one end of the outer spring steel plate 3-6 sleeves the adjusting bolt 3-5. The adjusting nut 3-7 is disposed on the adjusting bolt 3-5, and the adjusting nut 3-7 is located between an end head of the bending damper and the sidewall of the groove.

The outer spring steel plate 3-6 has a certain thickness. To facilitate the connection of the outer spring steel plate 3-6, one end of the outer spring steel plate 3-6 is thinned, and a hole is drilled in the thinned end head, enabling the connection of the outer spring steel plate 3-6 to the adjusting bolt 3-5 via the through hole. In other embodiments, the adjusting bolt 3-5 may be equivalently replaced with a shaft having an external thread, and the shaft may also be provided with steps, partially smooth surfaces, or the like.

Since the outer spring steel plate 3-6 has a tendency to stretch outward, the end head above the outer spring steel plate 3-6 has a tendency to move upward. An adjusting nut 3-7 is disposed on the adjusting bolt 3-5 between the end head above the outer spring steel plate 3-6 and the upper inner sidewall of the groove. The preload force between the adjusting nut 3-7 and the adjusting bolt 3-5 is used to restrict the upward movement of the end head above the outer spring steel plate 3-6, thereby altering its bending degree.

Here, in other embodiments, the adjusting nut 3-7 may alternatively be replaced with a flat structural component or a non-flat structural component having an internally threaded hole.

Moreover, the adjusting bolt 3-5 and the upper inner sidewall of the groove may be perpendicular or non-perpendicular.

Additionally, the adjusting apparatus further includes an adjusting spring 3-12, where the adjusting spring 3-12 sleeves the adjusting bolt 3-5, one end of the adjusting spring 3-12 abuts against the sidewall of the groove, and the other end of the adjusting spring 3-12 abuts against the adjusting nut 3-7.

Using the adjusting spring 3-12 enables the locking of the adjusting nut 3-7 with the adjusting bolt 3-5, preventing the adjusting nut 3-7 from loosening. This prevents frequency changes in the vibration absorbing head during use, effectively ensuring a consistently stable vibration damping effect.

The adjusting apparatus further includes a protective nut 3-8, where the protective nut 3-8 is disposed on the adjusting bolt 3-5 on an outer side of the end head of the bending damper. The arrangement of the protective nut 3-8 serves as a defensive mechanism to prevent the outer spring steel plate 3-6 from escaping from the lower end of the adjusting bolt 3-5 due to external factors. It can be understood that the protective nut 3-8 may be a nut or a machined component with an internally threaded hole.

As shown in FIG. 1, the outer wall of the head portion 3-1 is provided with a counterweight slot 3-2. The counterweight can be added via the counterweight slot 3-2 to adjust the weight of the head portion 3-1. The counterweight can be added as needed, providing more options for frequency adjustment.

The vibration absorbing head further includes a ball joint 3-3, where the ball joint 3-3 is disposed on a bottom wall of the groove for connecting to the steel strand cluster 2. Two bending dampers are provided, and the two bending dampers are symmetrically disposed on two sides of the steel strand cluster. Thus, the ball joint 3-3 is disposed at the center position of the bottom wall of the groove.

The head portion 3-1 is cylindrical, and the groove is arranged along an axis of the head portion 3-1, with the front and rear sides of the groove open. An end of the head portion 3-1 away from the groove is a spherical curved surface. In other embodiments, the head portion 3-1 may alternatively have a non-spherical curved surface or be a cylindrical end head with rounded chamfers, or the like.

The vibration damper provided by this embodiment, by means of adjusting the position of the adjusting nut 3-7, can adjust the bending degree of the outer spring steel plate 3-6, enabling free adjustment of the frequency of the bending damper, thus allowing the vibration damper to adapt to different vibration frequencies and various environmental conditions. Moreover, even if the swinging direction of the head portion 3-1 is inclined, the bending and stretching of the bending damper are not affected, meaning its vibration damping effect is not affected.

### Embodiment 7

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

The clamp 1 is used to grip the wire, thereby mounting the vibration damper on the wire. When the wire experiences breeze vibration, the clamp 1 can transmit the vibration energy to the steel strand cluster 2 and the vibration absorbing heads 3, achieving energy dissipation and vibration reduction through the friction and bending of the steel strand cluster 2, as well as the swinging, bending, and friction of the vibration absorbing heads 3.

Based on the above technical solution, the steel strand cluster 2 includes an upper steel strand 2-1, where the upper steel strand 2-1 is connected to the vibration absorbing head 3. Specifically, the upper steel strand 2-1 is connected to the ball joint 3-3 of the vibration absorbing head 3, thus allowing the vibration absorbing head 3 to swing around the ball joint 3-3 as the center.

In some embodiments, two upper steel strands 2-1 are provided, and the two upper steel strands 2-1 are horizontally arranged in parallel.

Additionally, the steel strand cluster 2 further includes a lower steel strand 2-2 and a steel wire 2-3, where the lower steel strand 2-2 is disposed below the upper steel strand 2-1, and two ends of the lower steel strand 2-2 are free ends. The steel wire 2-3 is wound around outer sides of the lower steel strand 2-2 and the upper steel strand 2-1.

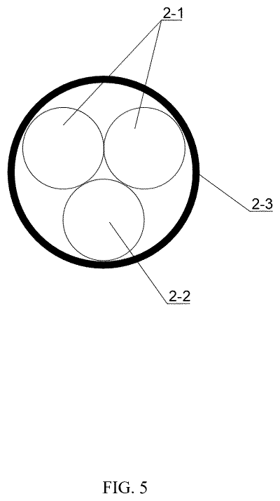

The lower steel strand 2-2 and the two upper steel strands 2-1 form an inverted triangular structure. The cross-sectional view of the steel strand cluster 2 is shown in FIG. 5.

The length of the lower steel strand 2-2 is less than the length of the upper steel strand 2-1. In addition, the upper steel strand 2-1 and the lower steel strand 2-2 may be of uniform specifications, or may be of different specifications.

The clamp 1 in this embodiment and the connection method between the clamp 1 and the steel strand cluster 2 may be the clamp and the connection method from the prior art, respectively, and their specific structures and principles are not elaborated herein.

According to the vibration damper provided by the present disclosure, the clamp 1 is used to grip the wire, thereby mounting the vibration damper on the wire. The steel strand cluster 2 is connected below the clamp 1, with the vibration absorbing heads 3 provided by the present disclosure disposed on two sides of the steel strand cluster 2. Based on the feature of the vibration absorbing head 3 freely adjusting the frequency, the vibration damper provided by the present disclosure can adapt to wires with different vibration frequencies and various environmental conditions.

According to the vibration damper provided by the present disclosure, the steel strand cluster 2 is used to connect the clamp 1 and the vibration absorbing head 3, where the steel strand cluster 2 includes two upper steel strands 2-1 and one lower steel strand 2-2. During wire vibration, the steel strands rub against each other, through the principle of friction-based energy dissipation, to further enhance the vibration reduction and damping effect of the vibration damper. Moreover, the steel strand cluster 2 in the present disclosure increases the friction area and adjustability between the steel strands. The increased friction area provides greater energy dissipation capacity, with two ends of the lower steel strand 2-2 being free ends. This facilitates replacement of the lower steel strand 2-2 without disassembling the head portion 3-1, thereby providing greater convenience and operability for frequency adjustment of the vibration damper. This also facilitates the maintenance of the vibration damper.

### Embodiment 8

This embodiment provides a broadband intelligent vibration damper for power transmission lines, as shown in FIG. 3 and FIG. 4, including a clamp 1, a steel strand cluster 2, and two vibration absorbing heads 3, where the clamp 1 is mounted at a middle portion of the steel strand cluster 2, and the two vibration absorbing heads 3 are respectively mounted at two ends of the steel strand cluster 2. The structure of the vibration absorbing head 3, as shown in FIG. 1, includes a head portion 3-1, where one end of the head portion 3-1 is provided with a U-shaped groove, a bottom surface of the groove is connected to the steel strand cluster 2, and a bending damper is disposed between the steel strand cluster 2 and a sidewall of the groove. One end of the bending damper is connected to the steel strand cluster 2 via a fixing apparatus 3-4, and the other end of the bending damper is connected to the sidewall of the groove of the head portion 3-1 via an adjusting apparatus. The bending degree of the bending damper can be adjusted via the adjusting apparatus.

The clamp 1 is used to grip the wire, thereby mounting the vibration damper on the wire. When the wire experiences breeze vibration, the clamp 1 can transmit the vibration energy to the steel strand cluster 2 and the vibration absorbing heads 3, achieving energy dissipation and vibration reduction through the friction and bending of the steel strand cluster 2, as well as the swinging, bending, and friction of the vibration absorbing heads 3.

The steel strand cluster 2 includes an upper steel strand 2-1, where the upper steel strand 2-1 is connected to the vibration absorbing head 3.

Specifically, the upper steel strand 2-1 is connected to the ball joint 3-3 of the vibration absorbing head 3, thus allowing the vibration absorbing head 3 to swing around the ball joint 3-3 as the center.

In some embodiments, two upper steel strands 2-1 are provided, and the two upper steel strands 2-1 are horizontally arranged in parallel.

Additionally, the steel strand cluster 2 further includes a lower steel strand 2-2 and a steel wire 2-3, where the lower steel strand 2-2 is disposed below the upper steel strand 2-1, and two ends of the lower steel strand 2-2 are free ends. The steel wire 2-3 is wound around outer sides of the lower steel strand 2-2 and the upper steel strand 2-1.

The lower steel strand 2-2 and the two upper steel strands 2-1 form an inverted triangular structure. The cross-sectional view of the steel strand cluster 2 is shown in FIG. 5.

The length of the lower steel strand 2-2 is less than the length of the upper steel strand 2-1. In addition, the upper steel strand 2-1 and the lower steel strand 2-2 may be of uniform specifications, or may be of different specifications.

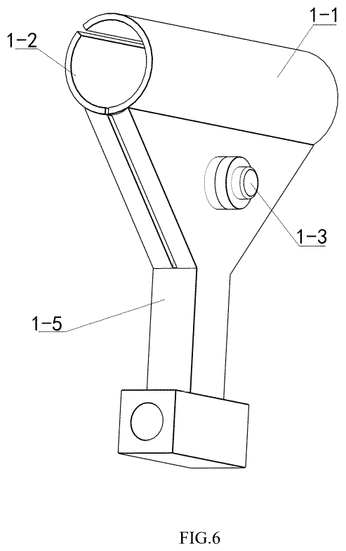

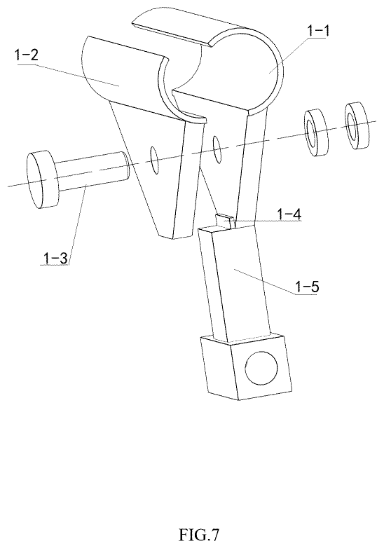

Based on the above technical solution, as shown in FIG. 6 and FIG. 7, the clamp 1 includes an annular tentacle 1-1, an independent tentacle 1-2, and a conductor 1-5, where a bottom end of the conductor 1-5 is connected to the middle portion of the steel strand cluster 2, an upper end of the conductor 1-5 is connected to the annular tentacle 1-1, the annular tentacle 1-1 is detachably connected to the independent tentacle 1-2, and a wire is disposed between the annular tentacle 1-1 and the independent tentacle 1-2.

In some embodiments, the annular tentacle 1-1 includes a first clamping jaw at an upper side and a first connecting plate below the first clamping jaw, where the first clamping jaw is configured to clamp the wire, and the first connecting plate is connected to the conductor 1-5.

In some embodiments, the cross-section of the first clamping jaw is a semicircular ring. It can be understood that the first clamping jaw may alternatively be configured as a structure with a cross-section of a ⅗ circular ring or other structural components with a certain curved shape.

In some embodiments, the first connecting plate is in an inverted trapezoidal shape, with the bottom of the first connecting plate connected to the conductor 1-5, and the top of the first connecting plate having the same length as the first clamping jaw with both ends aligned. The bottom of the first connecting plate has the same width as the upper end of the conductor 1-5.

In some embodiments, the independent tentacle 1-2 includes a second clamping jaw at an upper side and a second connecting plate below the second clamping jaw, where the second clamping jaw is configured to clamp the wire, and the second connecting plate is detachably connected to the first connecting plate.

The annular tentacle 1-1 and the independent tentacle 1-2 are arranged opposite each other; the structures of the independent tentacle 1-2 and the annular tentacle 1-1 may be the same or different. In this embodiment, the independent tentacle 1-2 and the annular tentacle 1-1 not only have the same structure but also the same dimensions; thus, the cross-section of the second clamping jaw of the independent tentacle 1-2 is also a semicircular ring, and the first clamping jaw and the second clamping jaw are arranged opposite each other to form a circular ring for clamping the wire. The second connecting plate also is in an inverted trapezoidal shape, with the top of the second connecting plate having the same length as the second clamping jaw and both ends aligned. The bottom of the second connecting plate has the same width as the upper end of the conductor 1-5.

In some embodiments, both the first connecting plate and the second connecting plate are provided with through holes, and a fastening bolt 1-3 is inserted through the through hole, enabling the detachable connection of the first connecting plate and the second connecting plate via the fastening bolt 1-3. In other embodiments, the fastening bolt 1-3 may alternatively be replaced with a double-ended stud or an equivalent component, secured with nuts at two ends of the double-ended stud. Alternatively, the first connecting plate and the second connecting plate may adopt other connection methods of, for example, providing a smooth hole in one connecting plate and a threaded hole in the other connecting plate, and tightening a screw from the smooth hole side to the threaded hole side to achieve fastening.

In some embodiments, a lever block 1-4 is disposed at the bottom between the first connecting plate and the second connecting plate. Preferably, the lever block 1-4 is welded to the first connecting plate. After the lever block 1-4 is added, there is a certain gap between the first connecting plate and the second connecting plate, such that the first connecting plate and the second connecting plate firmly clamp the wire when fastened, achieving rapid and effective energy transmission.

In some embodiments, the conductor 1-5 includes a transition block and a steel strand block below the transition block, where an upper part of the transition block is connected to the annular tentacle 1-1, a through hole is arranged inside the steel strand block, and the steel strand block is fixedly connected to the steel strand cluster 2 via the through hole therein.

In some embodiments, when the vibration damper is mounted on the wire, a posture of the vibration absorbing head 3 satisfies that the bending dampers on two sides of the steel strand cluster 2 are arranged vertically. In other words, as shown in FIG. 3, the two bending dampers on the left side of the vibration absorbing head 3 are arranged as one is above the other, with the outer spring steel plate 3-6 of the bending damper extending horizontally. Similarly, the two bending dampers on the right side of the vibration absorbing head 3 are arranged as one is above the other, with the outer spring steel plate 3-6 of the bending damper extending horizontally.

According to the vibration damper provided by the present disclosure, the clamp 1 is used to grip the wire, thereby mounting the vibration damper on the wire. The steel strand cluster 2 is connected below the clamp 1, with the vibration absorbing heads 3 provided by the present disclosure disposed on two sides of the steel strand cluster 2. Based on the feature of the vibration absorbing head 3 freely adjusting the frequency, the vibration damper provided by the present disclosure can adapt to wires with different vibration frequencies and various environmental conditions.

According to the vibration damper provided by the present disclosure, the steel strand cluster 2 is used to connect the clamp 1 and the vibration absorbing head 3, where the steel strand cluster 2 includes two upper steel strands 2-1 and one lower steel strand 2-2. During wire vibration, the steel strands rub against each other, through the principle of friction-based energy dissipation, to further enhance the vibration reduction and damping effect of the vibration damper. Moreover, the steel strand cluster 2 in the present disclosure increases the friction area and adjustability between the steel strands. The increased friction area provides greater energy dissipation capacity, with two ends of the lower steel strand 2-2 being free ends. This facilitates replacement of the lower steel strand 2-2 without disassembling the head portion 3-1, thereby providing greater convenience and operability for frequency adjustment of the vibration damper. This also facilitates the maintenance of the vibration damper.

The vibration damper provided by this embodiment has a clamp 1 that includes an annular tentacle 1-1 and an independent tentacle 1-2, with a lever block 1-4 disposed between the annular tentacle 1-1 and the independent tentacle 1-2. The lever block 1-4 creates a certain gap between the annular tentacle 1-1 and the independent tentacle 1-2, and fastening bolts 1-3 are used to secure the annular tentacle 1-1 and the independent tentacle 1-2, enabling the annular tentacle 1-1 to firmly grip the clamp 1 and generate a preload force to effectively transmit vibration energy, and allowing the wire to be gripped still tightly even when the wire diameter is reduced.

### Embodiment 9

This embodiment provides an optimization design method for broadband intelligent vibration damper, optimizing the design of the broadband intelligent vibration damper for power transmission lines provided in Embodiments 1 to 8. The specific optimization design method for broadband intelligent vibration damper includes:
S1: measuring a vibration angle αₘ and a maximum vibration frequency f at a wire hanging position of the power transmission lines;
S2: setting a frequency of one of the vibration absorbing heads to a first set value, setting a frequency of the other vibration absorbing head to a second set value, and setting an overall frequency of the vibration damper to a third set value without considering vibration of the vibration absorbing heads; and
S3: re-measuring the vibration angle at the wire hanging position after the vibration damper is mounted, and completing the mounting when a re-measured vibration angle is less than an allowable vibration angle; wherein when a maximum vibration angle exceeds the allowable vibration angle, counterweight should be added with the frequency of the vibration damper kept unchanged, and re-measuring is performed until the maximum vibration angle is less than the allowable vibration angle to complete mounting.

In some embodiments, the vibration angle αₘ satisfies:

$${α}_{m} = {tan}^{- 1} ( \frac{2 π {C}_{1}}{μ sin \frac{2 π l}{μ}} ) ;$$

where μ represents a vibration wave wavelength, C₁ represents an amplitude of a vibration wave at a measurement point, and l represents a distance between the measurement point and an entrance of the clamp.

In some embodiments, the maximum vibration frequency f satisfies:

$$f = \frac{1}{2 π} \sqrt{\frac{k}{m}} ;$$

where k represents a stiffness of the wire system, and m represents the wire mass.

In some embodiments, the first set value is 0.1 f.

In some embodiments, the second set value is 0.5 f.

In some embodiments, the third set value is 0.8 f.

In some embodiments, re-measuring the vibration angle at the wire hanging position specifically includes: after the vibration damper is mounted, the vibration angle is measured at least once or more, and the maximum value is taken as the re-measured vibration angle.

In some embodiments, the allowable vibration angle is 10′.

In some embodiments, in step S3, the addition of the counterweight with the frequency of the vibration damper kept unchanged specifically includes: one counterweight block with a mass of 50 g is added each time, and a position of the adjusting nut 3-7 is adjusted after the counterweight addition, to ensure the unchanged frequency of the vibration damper.

The optimization design method for broadband intelligent vibration damper provided by this embodiment includes: first measuring the maximum vibration frequency and vibration angle of the wire near the hanging position, and adjusting the natural frequencies of the two vibration absorbing heads 3 and the overall vibration damper to 0.1 f, 0.5 f, and 0.8 f. Then, after the frequency of the vibration damper is kept unchanged with the counterweight, the vibration angle is re-measured multiple times, and the maximum vibration angle is taken to ensure that the maximum vibration angle is less than the allowable vibration angle, thereby maximizing the vibration reduction and energy absorption effect.

The above specific implementations are only used to illustrate the technical solutions of the present disclosure and are not limiting. Although the present disclosure has been described in detail with reference to examples, those of ordinary skill in the art should understand that modifications or equivalent substitutions can be made to the technical solutions of the present disclosure without departing from the scope of the technical solutions of the present disclosure, all of which should be encompassed within the scope of the claims of the present disclosure.

What is claimed is:

1. A broadband intelligent vibration damper for power transmission lines, comprising: a clamp, a steel strand cluster, and two vibration absorbing heads, wherein the clamp is mounted at a middle portion of the steel strand cluster, and the two vibration absorbing heads are respectively mounted at two ends of the steel strand cluster; each of the two vibration absorbing heads comprises a head portion, one end of the head portion is provided with a groove, a bottom surface of the groove is connected to the steel strand cluster, and a bending damper is disposed between the steel strand cluster and a sidewall of the groove; the bending damper has one end connected to the steel strand cluster via a fixing apparatus and another end connected to the sidewall of the groove of the head portion via an adjusting apparatus; a bending degree of the bending damper is adjustable via the adjusting apparatus; the bending damper comprises an outer spring steel plate, one end of the outer spring steel plate is connected to the steel strand cluster via the fixing apparatus, and another end of the outer spring steel plate is connected to the sidewall of the groove of the head portion via the adjusting apparatus; the outer spring steel plate is curved.

2. The broadband intelligent vibration damper according to claim 1, wherein the bending damper further comprises an inner spring steel plate, and the inner spring steel plate is disposed on an inner side of the outer spring steel plate.

3. The broadband intelligent vibration damper according to claim 2, wherein a friction layer is disposed between the outer spring steel plate and the inner spring steel plate.

4. The broadband intelligent vibration damper according to claim 3, wherein the friction layer is a steel sheet.

5. The broadband intelligent vibration damper according to claim 3 or 4, wherein the inner surface of the friction layer is a rough surface, and/or the outer surface of the friction layer is a rough surface.

6. The broadband intelligent vibration damper for power transmission lines according to claim 5, wherein an inner surface friction coefficient of the friction layer is 0.35-0.45, and/or an outer surface friction coefficient of the friction layer is 0.4-0.5.

7. The broadband intelligent vibration damper according to claim 3, wherein the bending damper further comprises a first limiter and a second limiter, the first limiter is disposed on an inner side of an end head of the outer spring steel plate connected to the adjusting apparatus.

8. The broadband intelligent vibration damper according to claim 7, wherein the bending energy dissipator further includes a second limiter, where the second limiter is disposed on an inner side of a joint between the outer spring steel plate and the fixing apparatus.

9. The broadband intelligent vibration damper according to claim 1, wherein the fixing apparatus is a connecting block.

10. The broadband intelligent vibration damper according to claim 9, wherein the bending damper is rigidly connected to the fixing apparatus.

11. The broadband intelligent vibration damper according to claim 1, wherein the adjusting apparatus comprises an adjusting bolt and an adjusting nut, the adjusting bolt is disposed on the sidewall of the groove of the head portion, and one end of the bending damper sleeves the adjusting bolt; the adjusting nut is disposed on the adjusting bolt, and the adjusting nut is located between an end head of the bending damper and the sidewall of the groove.

12. The broadband intelligent vibration damper according to claim 11, wherein the adjusting apparatus further includes an adjusting spring, the adjusting spring sleeves the adjusting bolt, one end of the adjusting spring abuts against the sidewall of the groove, and another end of the adjusting spring abuts against the adjusting nut.

13. The broadband intelligent vibration damper according to claim 12, wherein the adjusting apparatus further includes a protective nut, and the protective nut is disposed on an outer side of the end head of the bending damper.

14. The broadband intelligent vibration damper according to claim 1, wherein an outer wall of the head portion is provided with a counterweight slot.

15. The broadband intelligent vibration damper according to claim 1, wherein each of the two vibration absorbing heads further comprises a ball joint, and the ball joint is disposed on a bottom wall of the groove for connecting to the steel strand cluster.

16. The broadband intelligent vibration damper according to claim 15, wherein two bending dampers are provided, and the two bending dampers are symmetrically disposed on two sides of the steel strand cluster.

17. The broadband intelligent vibration damper according to claim 1, wherein the head portion is cylindrical, and the groove is arranged along an axis of the head portion.

18. The broadband intelligent vibration damper according to claim 17, wherein an end of the head portion away from the groove is a spherical curved surface.

19. The broadband intelligent vibration damper according to claim 18, wherein a miniature acceleration sensor is disposed at a top of the spherical curved surface of the end of the head portion away from the groove.

20. The broadband intelligent vibration damper according to claim 19, wherein the acceleration sensor employs MEMS (Micro-Electro-Mechanical Systems) technology for self-powering, requiring no external power source.

21. The broadband intelligent vibration damper for power transmission lines according to claim 20, wherein a signal from the acceleration sensor can be transmitted via a wireless communication module mounted on a transmission tower, where the wireless transmission module is powered by a solar panel.

22. The broadband intelligent vibration damper according to claim 15, wherein the steel strand cluster comprises an upper steel strand, and the upper steel strand is connected to the vibration absorbing head.

23. The broadband intelligent vibration damper according to claim 22, wherein the upper steel strand is connected to the ball joint of the vibration absorbing head.

24. The broadband intelligent vibration damper according to claim 23, wherein two upper steel strands are provided, and the two upper steel strands are horizontally arranged in parallel.

25. The broadband intelligent vibration damper according to claim 24, wherein the steel strand cluster further includes a lower steel strand and a steel wire, the lower steel strand is disposed below the two upper steel strands, and two ends of the lower steel strand are free ends, the steel wire is wound around outer sides of the lower steel strand and the two upper steel strands, respectively.

26. The broadband intelligent vibration damper according to claim 25, wherein the lower steel strand and the two upper steel strands form an inverted triangular structure.

27. The broadband intelligent vibration damper according to claim 25, wherein a length of the lower steel strand is less than a length of each of the two upper steel strands.

28. The broadband intelligent vibration damper according to claim 1, wherein the clamp comprises an annular tentacle, an independent tentacle, and a conductor; a bottom end of the conductor is connected to the middle portion of the steel strand cluster, an upper end of the conductor is connected to the annular tentacle, the annular tentacle is detachably connected to the independent tentacle, and a wire is disposed between the annular tentacle and the independent tentacle.

29. The broadband intelligent vibration damper according to claim 28, wherein the annular tentacle comprises a first clamping jaw at an upper side and a first connecting plate below the first clamping jaw, the first clamping jaw is configured to clamp the wire, and the first connecting plate is connected to the conductor.

30. The broadband intelligent vibration damper according to claim 29, wherein a cross-section of the first clamping jaw is a semicircular ring.

31. The broadband intelligent vibration damper according to claim 29, wherein the first connecting plate is in an inverted trapezoidal shape.

32. The broadband intelligent vibration damper according to claim 29, wherein the independent tentacle comprises a second clamping jaw at an upper side and a second connecting plate below the second clamping jaw, where the second clamping jaw is configured to clamp the wire, and the second connecting plate is detachably connected to the first connecting plate.

33. The broadband intelligent vibration damper according to claim 32, wherein the independent tentacle comprises a second clamping jaw at an upper side and a second connecting plate below the second clamping jaw, the second clamping jaw is configured to clamp the wire, and the second connecting plate is detachably connected to the first connecting plate.

34. The broadband intelligent vibration damper according to claim 33, wherein a lever block is disposed at a bottom between the first connecting plate and the second connecting plate.

35. The broadband intelligent vibration damper according to claim 34, wherein the lever block is welded to the first connecting plate.

36. The broadband intelligent vibration damper according to claim 28, wherein the conductor comprises a transition block and a steel strand block below the transition block, an upper part of the transition block is connected to the annular tentacle, a through hole is arranged inside the steel strand block, and the steel strand block is fixedly connected to the steel strand cluster via the through hole therein.

37. The broadband intelligent vibration damper according to claim 28, when the vibration damper is mounted on the wire, a posture of the vibration absorbing head satisfies that the two bending dampers on two sides of the steel strand cluster are arranged vertically.

38. A design method for optimizing the broadband intelligent vibration damper according to any one of claims 1 to 37, comprising:
S1: measuring a vibration angle αₘ and a maximum vibration frequency f at a wire hanging position of the power transmission lines;
S2: setting a frequency of one of the vibration absorbing heads to a first set value, setting a frequency of the other vibration absorbing head to a second set value, and setting an overall frequency of the vibration damper to a third set value without considering vibration of the vibration absorbing heads; and
S3: re-measuring the vibration angle at the wire hanging position after the vibration damper is mounted, and completing the mounting when a re-measured vibration angle is less than an allowable vibration angle; wherein when a maximum vibration angle exceeds the allowable vibration angle, counterweight should be added with the frequency of the vibration damper kept unchanged, and re-measuring is performed until the maximum vibration angle is less than the allowable vibration angle to complete mounting.

39. The optimization design method for broadband intelligent vibration damper according to claim 38, wherein the vibration angle αₘ satisfies:
$${α}_{m} = {tan}^{- 1} ( \frac{2 π {C}_{1}}{μ sin \frac{2 π l}{μ}} ) ;$$
wherein μ represents a vibration wave wavelength, C₁ represents an amplitude of a vibration wave at a measurement point, and l represents a distance between the measurement point and an entrance of the clamp.

40. The design method according to claim 38, wherein the first set value is 0.1 f.

41. The design method for broadband intelligent vibration damper according to claim 38, wherein the second set value is 0.5 f.

42. The design method for broadband intelligent vibration damper according to claim 38, wherein the third set value is 0.8 f.

43. The design method for broadband intelligent vibration damper according to claim 38, wherein in step S3, the addition of the counterweight with the frequency of the vibration damper kept unchanged specifically comprises: adding one counterweight block with a mass of 50 g each time, and adjusting a position of an adjusting nut after the counterweight addition, to ensure the unchanged frequency of the vibration damper.
